(19) United States
(12) Patent Application Publication
(10) Pub. No.: US 2007/0076138 A1
(43) Pub. Date: Apr. 5, 2007

(54) Liquid crystal display monitor

(76) Inventors: Yung-Chun Chiu, Yung Ho City (TW); Wei-Li Luo, Yung Ho City (TW); Long-San Yang, Yung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/239,047

(22) Filed: Sep. 30, 2005

(51) Int. Cl. G02F 1/1333

(52) U.S. Cl. 349/58

(57) ABSTRACT

An LCD monitor includes a front shell, a display device, a back frame, an electrical circuit, and an EMI shield. The front shell provides the appearance and the strength of the LCD monitor. The display device is directly mounted on the back of the front shell. The front shell can protect the display device from damage. The back frame is mounted on the back of the display device for providing the strength of the LCD monitor and protecting the display device from damage. The electrical circuit is positioned on the back of the back frame and electrically connects with the display device for driving the display device. The EMI shield is mounted on the back of the back frame and contacts with the electrical circuit for shielding from an EMI. Furthermore, the EMI shield can improve an EMI shielding effect by directly contacting with the back frame.

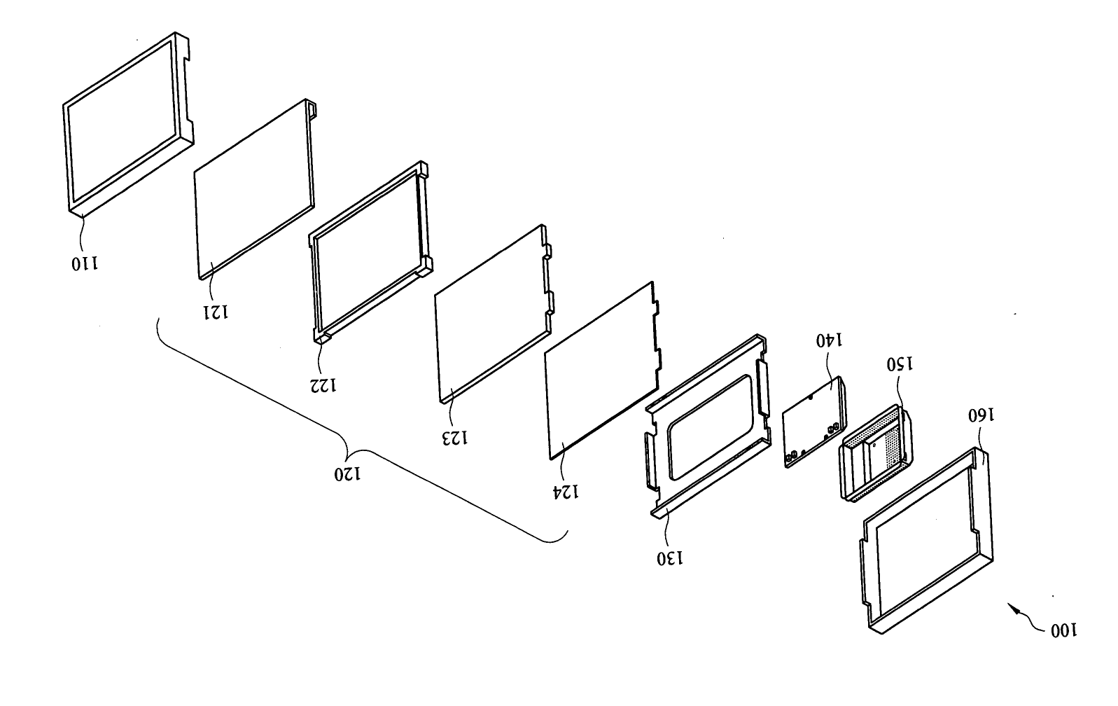

### BACKGROUND

1. Field of Invention

The present invention relates to a liquid crystal display (LCD) monitor. More particularly, the present invention relates to an LCD monitor with a simplified assembly procedure.

2. Description of Related Art

The liquid crystal display (LCD) monitor has many advantages over other conventional types of displays including high display quality, small volume, light weight, low driving voltage and low power consumption. Hence, LCD monitors are widely used in small portable televisions, mobile telephones, video recording units, notebook computers, desktop monitors, projector televisions and the like, and have gradually replaced the conventional cathode ray tube (CRT) as a mainstream display unit.

A traditional LCD monitor has a front shell, an LCD panel, a supporting structure, an electrical circuit, an electromagnetic interference (EMI) shield and a back shell. The front shell is used for providing the appearance and the strength of the LCD monitor. The LCD panel is mounted on the back of the front shell for providing the LCD monitor a display functionality. The supporting structure is mounted on the back of the LCD panel for providing the strength of the LCD monitor and making the LCD panel couple with other devices of the LCD monitor. The electrical circuit is positioned on the back of the supporting structure and electrically connects with the LCD panel for driving the LCD panel. The EMI shield is mounted on the back of the supporting structure and contacts the electrical circuit for shielding from EMI. The back shell is combined with the front shell to become a case. The case holds the LCD panel, the supporting structure, the electrical circuit and the EMI shield. The front shell and the back shell are often made of plastic.

The LCD panel has a front bezel, a glass substrate, a middle bezel, a light guide plate, at least one optical film and a back frame. The front bezel is configured on the front shell. The back frame is configured on the supporting structure. The middle bezel is mounted on the back of the front bezel. The glass substrate is positioned between the front bezel and the middle bezel. The back frame is mounted on the back of the middle bezel. The light guide plate and the optical film are both positioned in order between the middle bezel and the back frame.

As mentioned above, a traditional LCD monitor is assembled by way of configuring an LCD panel bought from panel manufacturers into the LCD monitor. The LCD monitor manufacturer needs to configure a front shell for providing the appearance and the strength of the LCD monitor even though the front bezel can provide the same functions because the LCD panel is a commercial product, not a custom one. Furthermore, a supporting structure is needed to be configured in the LCD monitor to enable the LCD panel to be coupled with other LCD monitor devices because the LCD panel alone cannot satisfy the assembly requirement. However, these additional elements increase the cost of the LCD monitor.

Moreover, to control EMI, a metal element is needed to cover the electrical circuit. In the traditional LCD monitor, there is a need for putting some conducting foam or conducting material between the EMI shield and the back frame because the contact between the LCD panel and other devices of the LCD monitor is bad.

Therefore, the designers, users and manufacturers of LCD monitors are most concerned with how to simplify the assembly procedure, raise the production efficiency, reduce the material cost and provide sufficient EMI shielding effect.

### SUMMARY

It is therefore an aspect of the present invention to provide an LCD monitor, whose display device is directly mounted on the back of the front shell, without a front bezel positioned between the display device and the front shell, such that the cost of the LCD monitor is reduced.

It is another aspect of the present invention to provide an LCD monitor, whose EMI shield directly contacts with the back frame, without a supporting structure positioned between the EMI shield and the back frame, such that the cost of the LCD monitor is reduced.

It is still another aspect of the present invention to provide an LCD monitor, wherein the EMI shield directly contacts with the back frame such that the EMI shielding effect is improved.

In accordance with the foregoing and other aspects of the present invention, an LCD monitor is provided. The LCD monitor includes a front shell, a display device, a back frame, an electrical circuit, and an EMI shield. The front shell provides the appearance and the strength of the LCD monitor. The display device is directly mounted on the back of the front shell. The front shell can protect the display device from damage. The back frame is mounted on the back of the display device for providing the strength of the LCD monitor and protecting the display device from damage. The electrical circuit is positioned on the back of the back frame and electrically connects with the display device for driving the display device. The EMI shield is mounted on the back of the back frame and contacts with the electrical circuit for shielding from EMI.

According to one preferred embodiment of the present invention, the display device has a glass substrate, a middle bezel, a light guide plate and at least one optical film. The middle bezel is directly mounted on the back of the front shell. The glass substrate is positioned between the middle bezel and the front shell. The back frame is mounted on the back of the middle bezel. The light guide plate and the optical film are positioned in order between the middle bezel and the back frame.

According to another preferred embodiment of present invention, the back frame has at least one frame coupler, and the EMI shield has at least one shield coupler for coupling with the frame coupler such that the EMI shield is mounted on the back of the back frame. The frame coupler and the shield coupler can be screws, glue, rivets or other structure.

The display device of the LCD monitor of the present invention is directly mounted on the back of the front shell such that a front bezel does not need to be mounted between the front shell and the display device. The back frame is directly mounted on the back of the display device such that a supporting structure does not need to be mounted between the display device and the back frame. Thus, the present invention can simplify the assembly procedure, raise the production efficiency and reduce the cost of the LCD monitor. Furthermore, the present invention can provide sufficient EMI shielding effect without incorporating conducting foam or conducting material because the EMI shield of the LCD monitor of the present invention directly contacts with the back frame.

It is to be understood that both the foregoing general description and the following detailed description are by examples and are intended to provide further explanation of the invention as claimed.

### BRIEF DESCRIPTION OF THE DRAWINGS

The invention can be more fully understood by reading the following detailed description of the preferred embodiment, with reference made to the accompanying drawing as follows:

The Figure is an exploded view of the LCD monitor according to one preferred embodiment of this invention.

### DESCRIPTION OF THE PREFERRED EMBODIMENTS

Reference will now be made in detail to the present preferred embodiments of the invention, an example of which is illustrated in the accompanying drawing. Wherever possible, the same reference numbers are used in the drawing and the description to refer to the same or like parts. Reference is made to the Figure wherein an LCD monitor 100 includes a front shell 110, a display device 120, a back frame 130, an electrical circuit 140, and an EMI shield 150. The front shell 110 provides the appearance and the srength of the LCD monitor 100.

The display device 120 is directly mounted on the back of the front shell 110. The front shell 110 can protect the display device 120 from damage. the back frame 130 is mounted on the back of the display device 120 for providing the strength of the LCD monitor 100 and protecting the display device 120 from damage.

The electrical circuit 140 is positioned on the back of the back frame 130 and electrically connects with the display device 120 for driving the display device 120. The EMI shield 150 is mounted on the back of the back frame 130 and contacts with the electrical circuit 140 for shielding from an EMI. Furthermore, because the EMI shield 150 directly contacts with the back frame 130, the EMI shielding effect is improved.

In one preferred embodiment, the display device 120 has a glass substrate 121, a middle bezel 122, a light guide plate 123 and at least one optical film 124. The middle bezel 122 is directly mounted on the back of the front shell 110. The glass substrate 121 is positioned between the middle bezel 122 and the front shell 110. The back frame 130 is mounted on the back of the middle bezel 122. The light guide plate 123 and the optical film 124 are positioned in order between the middle bezel 122 and the back frame 130.

A back shell 160 is combined with the front shell 110 to become a case, the case holding the display device 120, the back frame 130, the electrical circuit 140 and the EMI shield 150 for providing the appearance and the strength of the LCD monitor 100 in the Figure. The frontshell 110 and the back shell 160 can be made of plastic. However, the front shell 110 and the back shell 160 can also be made of mental, alloy, carbon fiber or other material.

Although it is not shown in FIG., the back frame may have at least one frame coupler, and the EMI shield may have at least one shield coupler for coupling with the frame coupler such that the EMI shield is mounted on the back of the back frame. The frame coupler and the shield coupler can be screws, glue, rivets or other structure.

In conclusion, the invention has advantages as follows:

(1) The display device of the LCD monitor of the present invention is directly mounted on the back of the front shell such that a front bezel does not need to be mounted between the front shell and the display device, and thus the cost of the LCD monitor of the present invention is reduced.

(2) The back frame is directly mounted on the back of the display device such that a supporting structure does not need to be mounted between the display device and the back frame, and thus the cost of the LCD monitor of the present invention is reduced.

(3) The present invention can provide sufficient EMI shielding effect without incorporating conducting foam or conducting material because the EMI shield of the LCD monitor of the present invention directly contacts with the back frame.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An LCD monitor, comprising:
a front shell used for providing the appearance and the strength of the LCD monitor;
a display device directly mounted on the back of the front shell whereby the front shell prevents the display device from damage;
a back frame mounted on the back of the display device for providing the strength of the LCD monitor and preventing the display device from damage;
an electrical circuit positioned on the back of the back frame and electrically connecting with the display device for driving the display device; and
an EMI shield mounted on the back of the back frame and contacting with the electrical circuit for shielding from an EMI.

2. The LCD monitor of claim 1, wherein the display device has a middle bezel mounted on the back of the front shell.

3. The LCD monitor of claim 2, wherein the display device has a glass substrate positioned between the front shell and the middle bezel.

4. The LCD monitor of claim 2, wherein the back frame is mounted on the back of the middle bezel.

5. The LCD monitor of claim 4, wherein the display device has a light guide plate and at least one optical film both positioned between the middle bezel and the back frame.

6. The LCD monitor of claim 1, further comprising a back shell combined with the front shell to become a case, the case holding the display device, the back frame, the electrical circuit and the EMI shield for providing the appearance and the strength of the LCD monitor, wherein the front shell and the back shell are made of plastic.

7. The LCD monitor of claim 1, wherein the back frame has at least one frame coupler, and the EMI shield has at least one shield coupler for coupling with the frame coupler such that the EMI shield is mounted on the back of the back frame.

8. An LCD monitor, comprising:
a front shell used for providing the appearance and the strength of the LCD monitor;
a front bezel mounted on the back of the front shell;
a display device directly mounted on the back of the front bezel whereby the front bezel prevents the display device from damage;
a back frame mounted on the back of the display device for providing the strength of the LCD monitor and preventing the display device from damage;
an electrical circuit positioned on the back of the back frame and electrically connecting with the display device for driving the display device; and
an EMI shield mounted on the back of the back frame and contacting with the electrical circuit for shielding from an EMI.

9. The LCD monitor of claim 8, wherein the display device has a middle bezel mounted on the back of the front bezel.

10. The LCD monitor of claim 9, wherein the display device has a glass substrate positioned between the front bezel and the middle bezel.

11. The LCD monitor of claim 9, wherein the back frame is mounted on the back of the middle bezel.

12. The LCD monitor of claim 11, wherein the display device has a light guide plate and at least one optical film both positioned between the middle bezel and the back frame.

13. The LCD monitor of claim 8, further comprising a back shell combined with the front shell to become a case, the case holding the front bezel, the display device, the back frame, the electrical circuit and the EMI shield for providing the appearance and the strength of the LCD monitor, wherein the front shell and the back shell are made of plastic.

14. The LCD monitor of claim 8, wherein the back frame has at least one frame coupler, and the EMI shield has at least one shield coupler for coupling with the frame coupler such that the EMI shield is mounted on the back of the back frame.

15. An LCD monitor, comprising:
a front shell used for providing the appearance and the strength of the LCD monitor;
a display device directly mounted on the back of the front shell whereby the front shell prevents the display device from damage;
a back frame mounted on the back of the display device for preventing the display device from damage;
a supporting structure mounted on the back of the back frame for providing the strength of the LCD monitor;
an electrical circuit positioned on the back of the back frame and electrically connecting with the display device for driving the display device; and
an EMI shield mounted on the back of the supporting structure and contacting with the electrical circuit for shielding an EMI.

16. The LCD monitor of claim 15, wherein the display device has a middle bezel mounted on the back of the front shell.

17. The LCD monitor of claim 16, wherein the display device has a glass substrate positioned between the front shell and the middle bezel.

18. The LCD monitor of claim 16, wherein the back frame is mounted on the back of the middle bezel.

19. The LCD monitor of claim 18, wherein the display device has a light guide plate and at least one optical film both positioned between the middle bezel and the back frame.

20. The LCD monitor of claim 15, further comprising a back shell combined with the front shell to become a case, the case holding the display device, the back frame, the supporting structure, the electrical circuit and the EMI shield for providing the appearance and the strength of the LCD monitor, wherein the front shell and the back shell are made of plastic.
